(19) United States
(12) Patent Application Publication
(10) Pub. No.: US 2026/0164233 A1
(43) Pub. Date: Jun. 11, 2026

(54) SECURE SHORT MESSAGING SERVICE

(71) Applicant: Cisco Technology, Inc., San Jose, CA (US)

(72) Inventors: Elango GANESAN, Portola Valley, CA (US); Yen Chih Lee, San Jose, CA (US); Michael Freed, Pleasanton, CA (US); Siva Rama Krishna Yaragalla, Bengalore (IN)

(21) Appl. No.: 19/040,273

(22) Filed: Jan. 29, 2025

Related U.S. Application Data
(60) Provisional application No. 63/728,383, filed on Dec. 5, 2024.

(51) Int. Cl. H04W 12/03; H04W 4/14

(52) U.S. Cl. CPC H04W 12/03; H04W 4/14

(57) ABSTRACT

In one embodiment, an example method herein may comprise: encrypting, by a device on a cellular communication network, a message into a plurality of encrypted bytes, the message intended for one or more recipient devices with respective cellular network phone numbers; converting, by the device, the plurality of encrypted bytes into a set of seven-bit alphanumeric symbols, the set having no greater than a maximum number of allowed symbols for secure messaging service messages on the cellular communication network; and sending, by the device, the set of seven-bit alphanumeric symbols as a secure messaging service message on the cellular communication network to each of the one or more recipient devices at their respective cellular network phone numbers to cause the one or more recipient devices to decrypt the message.

### RELATED APPLICATION

This application claims priority to U.S. Provisional Application No. 63/728,383, filed Dec. 5, 2024, entitled SECURE SHORT MESSAGING SERVICE INSETS, by Elango Ganesan, et al., the contents of which are incorporated herein by reference.

### TECHNICAL FIELD

The present disclosure relates generally to computer networks, and, more particularly, to secure short messaging service (SMS).

### BACKGROUND

Networking devices, particularly Internet of Things (IoT) devices, are often deployed in remote locations or locations that are not readily accessible, far away from wired networking infrastructure. Typically, these devices have internet connectivity via cellular wireless network, which then enables the devices to be remotely managed. However, issues on the device (e.g., configuration errors) or in the cellular network may result in loss of internet connectivity, resulting in a very expensive “truck roll” to send a field technician to the remote location to troubleshoot and repair the disconnected device.

To avoid the expensive truck rolls, some vendors have provided a backup communication channel via short messaging service (SMS), which can be used to gather some device status information as well as issue limited commands to the device to attempt issue resolution. While helpful, however, there are issues with the existing available services, such as lack of security, cumbersome management, and limitation in message length.

### BRIEF DESCRIPTION OF THE DRAWINGS

The embodiments herein may be better understood by referring to the following description in conjunction with the accompanying drawings in which like reference numerals indicate identically or functionally similar elements, of which:

FIG. 1 illustrates an example computing system;

FIG. 2 illustrates an example network device/node;

FIG. 3 illustrates an example of a cellular modem with separate data and control channels;

FIG. 4 illustrates an example architecture for a secure short messaging service (SMS) according to one or more embodiments herein;

FIG. 5 illustrates an example architecture for a cloud-based secure SMS according to one or more embodiments herein;

FIG. 6 illustrates an example procedure for device-to-device secure SMS according to one or more embodiments herein; and

FIG. 7 illustrates an example procedure for secure SMS according to one or more embodiments herein.

### DESCRIPTION OF EXAMPLE EMBODIMENTS

### Overview

According to one or more embodiments of the disclosure, secure short messaging service (SMS) is provided herein. That is, the techniques herein propose a new “Secure SMS” service that adds security via end-to-end encryption, provide a cloud-based service for ease of management and use, and convert messages into efficient GSM-7 encoding to pack more information. This is particularly important for use when troubleshooting a failed cellular data connection by using a backup cellular SMS channel. Secure SMS may also be used herein for general router-to-router communication, particular for issuing a limited set of commands or requests from “leaders” to “targets”, accordingly.

In one embodiment, an example method herein may comprise: encrypting, by a device on a cellular communication network, a message into a plurality of encrypted bytes, the message intended for one or more recipient devices with respective cellular network phone numbers; converting, by the device, the plurality of encrypted bytes into a set of seven-bit alphanumeric symbols, the set having no greater than a maximum number of allowed symbols for secure messaging service messages on the cellular communication network; and sending, by the device, the set of seven-bit alphanumeric symbols as a secure messaging service message on the cellular communication network to each of the one or more recipient devices at their respective cellular network phone numbers to cause the one or more recipient devices to decrypt the message.

Other implementations are described below, and this overview is not meant to limit the scope of the present disclosure.

### Description

A computer network is a geographically distributed collection of nodes interconnected by communication links and segments for transporting data between end nodes, such as personal computers and workstations, or other devices, such as sensors, etc. Many types of networks are available, ranging from local area networks (LANs) to wide area networks (WANs). LANs typically connect the nodes over dedicated private communications links located in the same general physical location, such as a building or campus. WANs, on the other hand, typically connect geographically dispersed nodes over long-distance communications links, such as common carrier telephone lines, optical lightpaths, synchronous optical networks (SONET), synchronous digital hierarchy (SDH) links, and others. The Internet is an example of a WAN that connects disparate networks throughout the world, providing global communication between nodes on various networks. Other types of networks, such as field area networks (FANs), neighborhood area networks (NANs), personal area networks (PANs), enterprise networks, etc. may also make up the components of any given computer network. In addition, a Mobile Ad-Hoc Network (MANET) is a kind of wireless ad-hoc network, which is generally considered a self-configuring network of mobile routers (and associated hosts) connected by wireless links, the union of which forms an arbitrary topology.

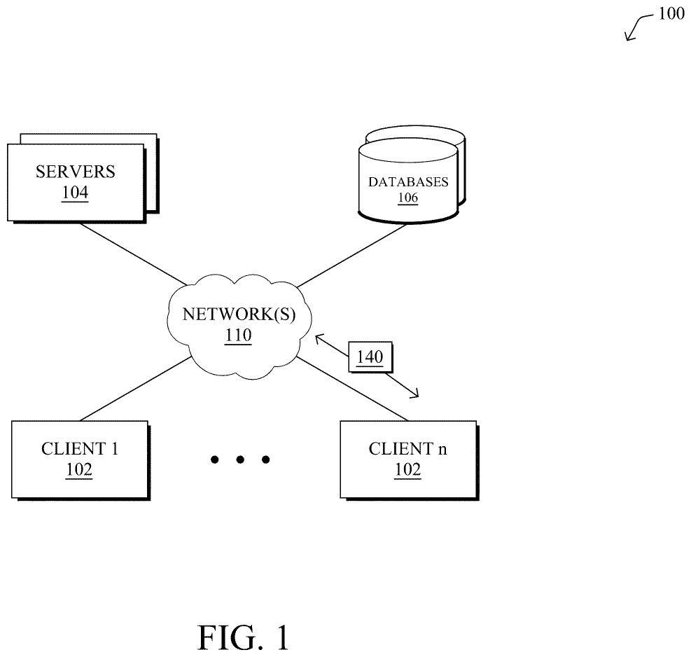

FIG. 1 is a schematic block diagram of an example simplified computing system (e.g., computing system 100) illustratively comprising any number of client devices (e.g., client devices 102, such as a first through nth client device), one or more servers (e.g., servers 104), and one or more databases (e.g., databases 106), where the devices may be in communication with one another via any number of networks (e.g., network(s) 110). The one or more networks (e.g., network(s) 110) may include, as would be appreciated, any number of specialized networking devices such as routers, switches, access points, etc., interconnected via wired and/or wireless connections. For example, the devices shown and/or the intermediary devices in network(s) 110 may communicate wirelessly via links based on WiFi, cellular, infrared, radio, near-field communication, satellite, or the like. Other such connections may use hardwired links, e.g., Ethernet, fiber optic, etc. The nodes/devices typically communicate over the network by exchanging discrete frames or packets of data (packets 140) according to predefined protocols, such as the Transmission Control Protocol/Internet Protocol (TCP/IP) other suitable data structures, protocols, and/or signals. In this context, a protocol consists of a set of rules defining how the nodes interact with each other.

Network(s) 110 may include, for example, network backbones or other internetworking systems, and may include various customer edge (CE) routers interconnected with provider edge (PE) routers in order to communicate across a core network to provide connectivity between devices which may be located in different geographical areas and/or on different types of local networks (e.g., local/branch networks versus data center/cloud environments). For example, these routers may be interconnected by the public Internet, a multiprotocol label switching (MPLS) virtual private network (VPN), or the like. In some implementations, a router or a set of routers may be connected to a private network (e.g., dedicated leased lines, an optical network, etc.) or a VPN (e.g., MPLS VPN) thanks to a carrier network, via one or more links exhibiting different network and service level agreement characteristics.

Client devices 102 may include any number of user devices or end point devices configured to interface with the techniques herein. For example, client devices 102 may include, but are not limited to, desktop computers, laptop computers, tablet devices, smart phones, wearable devices (e.g., heads up devices, smart watches, etc.), set-top devices, smart televisions, Internet of Things (IoT) devices, autonomous devices, or any other form of computing device capable of participating with other devices via network(s) 110.

Notably, in some implementations, servers 104 and/or databases 106, including any number of other suitable devices (e.g., firewalls, gateways, and so on) may be part of a cloud-based service. In such cases, the servers and/or databases 106 may represent the cloud-based device(s) that provide certain services described herein, and may be distributed, localized (e.g., on the premise of an enterprise, or “on prem”), or any combination of suitable configurations, as will be understood in the art. Servers 104, for example, may be configured as a network controller/supervisory service located in a data center with databases 106, accordingly. For instance, servers 104 may include, in various implementations, a network management server (NMS), a dynamic host configuration protocol (DHCP) server, a constrained application protocol (CoAP) server, an outage management system (OMS), an application policy infrastructure controller (APIC), an application server, etc.

Those skilled in the art will also understand that any number of nodes, devices, links, etc. may be used in computing system 100, and that the view shown herein is for simplicity. As would also be appreciated, computing system 100 may include any number of local networks, data centers, cloud environments, devices/nodes, servers, etc. Also, those skilled in the art will further understand that while the network is shown in a certain orientation, the computing system 100 is merely an example illustration that is not meant to limit the disclosure.

For instance, smart object networks, such as sensor networks, in particular, are a specific type of network (e.g., computing system 100) having spatially distributed autonomous devices such as sensors, actuators, etc., that cooperatively monitor physical or environmental conditions at different locations, such as, e.g., energy/power consumption, resource consumption (e.g., water/gas/etc. for advanced metering infrastructure or “AMI” applications) temperature, pressure, vibration, sound, radiation, motion, pollutants, etc. Other types of smart objects include actuators, e.g., responsible for turning on/off an engine or perform any other actions. Sensor networks, a type of smart object network, are typically shared-media networks, such as wireless or PLC networks. That is, in addition to one or more sensors, each sensor device (node) in a sensor network may generally be equipped with a radio transceiver or other communication port such as PLC, a microcontroller, and an energy source, such as a battery. Generally, size and cost constraints on smart object nodes (e.g., sensors) result in corresponding constraints on resources such as energy, memory, computational speed and bandwidth.

In some implementations, the techniques herein may be applied to still other network topologies and configurations. For example, the techniques herein may be applied to peering points with high-speed links, data centers, etc.

Notably, web services can be used to provide communications between electronic and/or computing devices over a network, such as the Internet. A web site is an example of a type of web service. A web site is typically a set of related web pages that can be served from a web domain. A web site can be hosted on a web server. A publicly accessible web site can generally be accessed via a network, such as the Internet. The publicly accessible collection of web sites is generally referred to as the World Wide Web (WWW).

Also, cloud computing generally refers to the use of computing resources (e.g., hardware and software) that are delivered as a service over a network (e.g., typically, the Internet). Cloud computing includes using remote services to provide a user's data, software, and computation.

Moreover, distributed applications can generally be delivered using cloud computing techniques. For example, distributed applications can be provided using a cloud computing model, in which users are provided access to application software and databases over a network. The cloud providers generally manage the infrastructure and platforms (e.g., servers/appliances) on which the applications are executed. Various types of distributed applications can be provided as a cloud service or as a Software as a Service (SaaS) over a network, such as the Internet.

According to various implementations, a software-defined WAN (SD-WAN) may be used in computing system 100 to connect local networks and data center/cloud environments. In general, an SD-WAN uses a software defined networking (SDN)-based approach to instantiate tunnels on top of the physical network and control routing decisions, accordingly. For example, one tunnel may connect a customer edge (CE) router at the edge of a local network to a remote CE router at the edge of a data center/cloud environment over an MPLS or Internet-based service provider network in a network backbone. Similarly, a second tunnel may also connect these routers over a 4G/5G/LTE cellular service provider network. SD-WAN techniques allow the WAN functions to be virtualized, essentially forming a virtual connection between local networks and data center/cloud environments on top of the various underlying connections. Another feature of SD-WAN is centralized management by a supervisory service that can monitor and adjust the various connections, as needed.

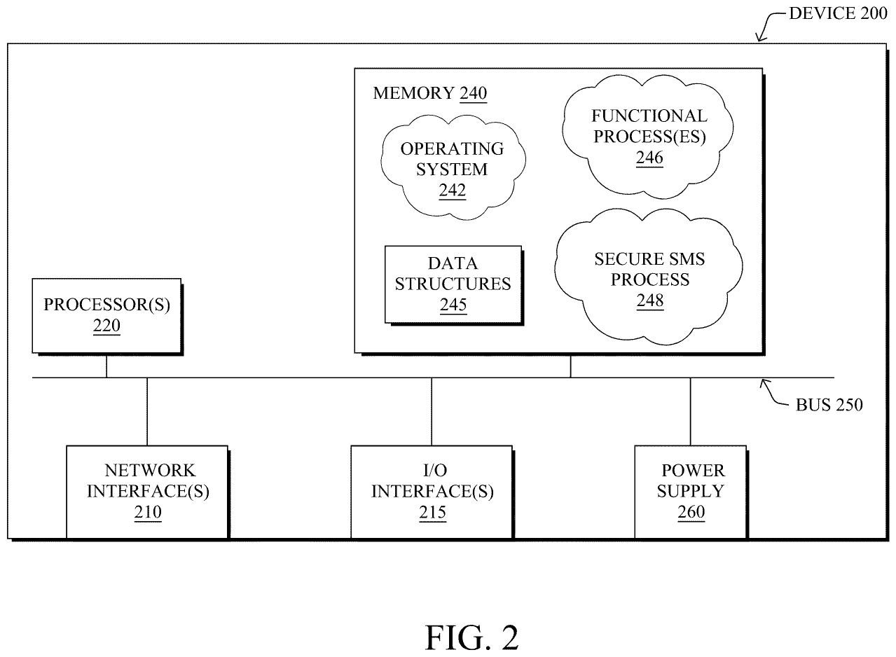

FIG. 2 is a schematic block diagram of an example node/device 200 (e.g., an apparatus) that may be used with one or more implementations described herein, e.g., as any of the nodes or devices shown in FIG. 1 above or described in further detail below. The device 200 may comprise one or more of the network interfaces 210 (e.g., wired, wireless, etc.), input/output interfaces (I/O interfaces 215, inclusive of any associated peripheral devices such as displays, keyboards, cameras, microphones, speakers, etc.), at least one processor (e.g., processor(s) 220), and a memory 240 interconnected by a system bus 250, as well as a power supply 260 (e.g., battery, plug-in, etc.).

The network interfaces 210 include the mechanical, electrical, and signaling circuitry for communicating data over physical links coupled to the computing system 100. The network interfaces may be configured to transmit and/or receive data using a variety of different communication protocols. Notably, a physical network interface (e.g., network interfaces 210) may also be used to implement one or more virtual network interfaces, such as for virtual private network (VPN) access, known to those skilled in the art.

The memory 240 comprises a plurality of storage locations that are addressable by the processor(s) 220 and the network interfaces 210 for storing software programs and data structures associated with the implementations described herein. The processor(s) 220 may comprise necessary elements or logic adapted to execute the software programs and manipulate the data structures 245. An operating system 242 (e.g., the Internetworking Operating System, or IOS®, of Cisco Systems, Inc., another operating system, etc.), portions of which are typically resident in memory 240 and executed by the processor(s), functionally organizes the node by, inter alia, invoking network operations in support of software processors and/or services executing on the device. These software processors and/or services may comprise one or more functional processes 246, and on certain devices, a secure SMS process (process 248), as described herein, each of which may alternatively be located within individual network interfaces.

Notably, one or more functional processes 246, when executed by processor(s) 220, cause each device 200 to perform the various functions corresponding to the particular device's purpose and general configuration. For example, a router would be configured to operate as a router, a server would be configured to operate as a server, an access point (or gateway) would be configured to operate as an access point (or gateway), a client device would be configured to operate as a client device, and so on.

It will be apparent to those skilled in the art that other processor and memory types, including various computer-readable media, may be used to store and execute program instructions pertaining to the techniques described herein. Also, while the description illustrates various processes, it is expressly contemplated that various processes may be implemented as modules configured to operate in accordance with the techniques herein (e.g., according to the functionality of a similar process). Further, while processes may be shown and/or described separately, those skilled in the art will appreciate that processes may be routines or modules within other processes.

### Secure SMS

As noted above, networking devices, particularly Internet of Things (IoT) devices, are often deployed in remote locations or locations that are not readily accessible, far away from wired networking infrastructure. Typically, these devices have internet connectivity via cellular wireless network, which then enables the devices to be remotely managed. However, issues on the device (e.g., configuration errors) or in the cellular network may result in loss of internet connectivity, resulting in a very expensive “truck roll” to send a field technician to the remote location to troubleshoot and repair the disconnected device.

As also noted above, to avoid the expensive truck rolls, some vendors have provided a backup communication channel via short messaging service (SMS), which can be used to gather some device status information as well as issue limited commands to the device to attempt issue resolution. While helpful, however, there are issues with the existing available services.

First, the existing solutions are not secure. The existing solutions send the messages as clear text, and either have no authentication or send authentication password in the clear. An attacker that intercepts the SMS messages will be able to easily see the information, and with the discovered password can then take over the networking device and issue potentially destructive or disruptive commands.

Second, the existing solutions are cumbersome to manage. SMS commands are sent directly from, for example, a user's mobile phone. The device will only respond if the user's phone number is configured in an explicit allow list. This means that if there are ten technicians supporting a device, all ten phone numbers must be configured on the device. And if there are 1,000 devices, then all ten technician phone numbers must be configured on all 1,000 devices. Total number of fields to be configured would therefore be 10*1,000=10,000 (“the cross-product problem”).

Third, the SMS messaging limits the number of characters that can be transmitted to about 140-160. If care is not taken in the message encoding to keep the characters within the Global System for Mobile Communications (GSM) character set defined by the cellular standards, the message length can double and may result in messages being dropped. This limits the amount of information that can be sent in a single message.

The techniques herein, therefore, propose a new “Secure SMS” service that adds security via end-to-end encryption, provide a cloud-based service for ease of management and use, and convert messages into efficient GSM-7 encoding to pack more information. This is particularly important for use when troubleshooting a failed cellular data connection by using a backup cellular SMS channel. Secure SMS may also be used herein for general router-to-router communication, particular for issuing a limited set of commands or requests from “leaders” to “targets”, accordingly.

In particular, the techniques herein address the issues described above, namely:
1. By adding security via end-to-end encryption;
2. By using a cloud-based service for ease of management and use; and
3. Through efficient encoding to pack more information into messages.

First, that is, the techniques herein enhance security of a backup channel with end-to-end encryption. An attacker intercepting the SMS message would not be able to see the information without breaking the encryption. Other vendor solutions are not secure since messages, even password, are sent in clear text. While end-to-end encryption itself is understood by those skilled in the art, details of enabling end-to-end encryption within an SMS backup channel are described in greater detail below.

Second, with a cloud-based service, the techniques herein allow for easier management overall. That is, each device only needs to allow one phone number from the cloud, as the user can use an IoT Operations Dashboard (OD) (or other controller system) as the interface for the service. Those phone numbers may be provisioned automatically as part of the device enrollment process. There are no longer any operator phone numbers to maintain. Additionally, with the cloud-based service, the techniques herein enhance security by keeping track of the state of device messaging (e.g., sequence numbers), which enables implementation of anti-reply mechanisms, preventing attackers from blindly resending captured encrypted messages. Other solutions cannot do this as message are sent directly to the user. Furthermore, with the cloud-based service, the techniques herein can implement health checks to validate and ensure availability of the SMS backup channel. Other solutions would require operators to manually initiate tests of the SMS channel periodically. Details of the use of a cloud-based interface for SMS backup channel according to the embodiments herein are also described further below.

Third, in one or more embodiments herein, the service controls the messages being sent, thus the techniques herein can implement a custom efficient encoding scheme to map optimally to the GSM SMS encoding character set and maximize the amount of information that can be transmitted in the message. Having the cloud-based user interface also means that the techniques herein can condense the information transmitted in the message and perform the formatting in the cloud to a user-friendly presentation. (Other vendor solutions cannot do the same since their messages are sent directly to the user.) In particular, custom efficient encoding herein may begin with the input in the form of encrypted bytes. SMS uses a standard-specified character set called “GSM 3.38” which consist of 7-bit symbols. The techniques herein first take the encrypted bytes which are 8-bits, extract and re-pack them as 7-bits, adding padding if necessary, and also handle the specific case of GSM extension characters (0x1b). Whenever the output includes the special extension character, the techniques herein can add a follow-on 7-bit GSM symbol, though that consumes an additional character slot out of the limited maximum allowed in a message. In the rare case where the additional character(s) push the message beyond the limit, the techniques herein can repeat encryption to generate a different set of encrypted bytes that possibly have fewer extension characters in the output.

Operationally, the techniques herein are based on devices with cellular connectivity. In one embodiment, for instance, such devices are specifically based on cellular modems and technician/operator devices attempting to communicate with the cellular modems (e.g., for troubleshooting), though other configurations of cellular-based communicating devices are possible according to the techniques herein.

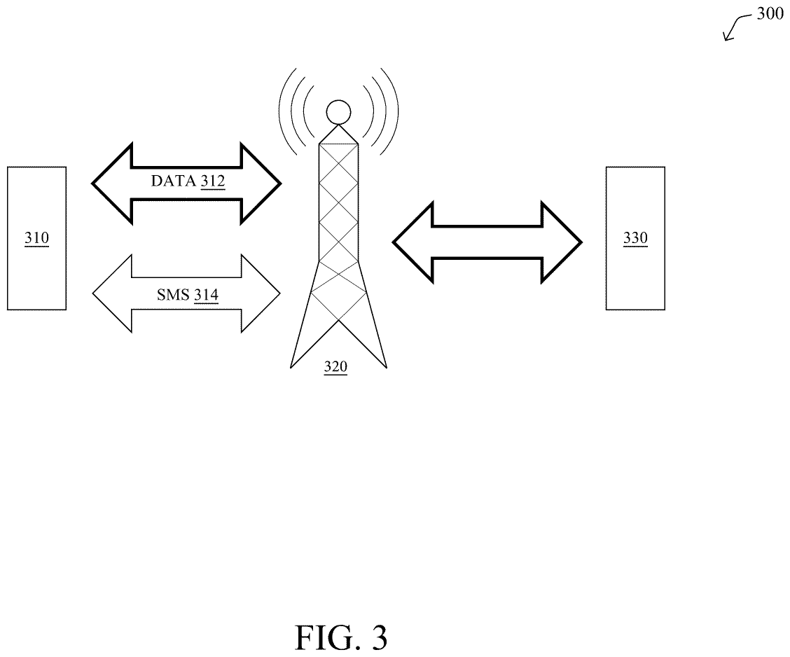

FIG. 3, in particular, illustrates an example environment 300 of a cellular modem 310 with a data channel 312 and a control channel 314 that are separate from each other, and that communicate via a communication network 320 to any number of devices 330 (e.g., IoT devices, computing devices, cloud devices, and so on). In general, the data and control channel are each cellular channels, though in one embodiment the data channel may be wired or other wireless communication mediums. Control channel 314, according to one or more embodiments herein, may specifically comprise a cellular channel, and more particularly, may be based on short messaging service (SMS) communication.

As will be understood by those skilled in the art, lost connectivity results in unreliable service, which leads to dissatisfied customers (and lost revenue). Customers may deploy thousands of industrial routers and rely on the connectivity provided by them to operate their businesses. A significant portion of these devices use cellular internet over an active cellular data path, thus a loss of connectivity is particularly burdensome.

Cellular modems have two separate channels, the data channel 312 and the control channel 314. Typically, the control channel 314 is used for SMS, so according to the techniques herein, if the data channel 312 is down, communication (e.g., troubleshooting) may instead be performed over SMS.

Notably, existing solutions that use SMS for troubleshooting in this manner suffer from a number of issues, such as those mentioned above (e.g., a lack of security, a lack of accessibility, a lack of message efficiency, etc.). For instance, while there is a notion of a “device password” which is supposed to indicate which messages are accepted by the device, SMS is not a secure channel and thus messages carrying a device password are unencrypted (i.e., the passwords are sent in the clear). For instance, the below example SMS messages demonstrate how current techniques attempt to send messages:
Example 1—Security using an SMS “allowlist”:
   “1234,apn,broadband,int1,SIM1,PDN1”
Example 2—No Security:
   “smsPwd=12345,apn=isp.example.com,usr=testUser, pwd=testPassword,act=reboot”
      As can be seen in the above example SMS messages, both change the access point name (APN) just from reading them. Example 1 has allowlists as a security measure, while Example 2 does not provide any such security measure. Allowlists, however, are difficult to configure with multiple sending devices and gateways-even with four phones and five gateways, allowlists could become convoluted and difficult to scale (twenty configured entries).

In order to adequately provide troubleshooting over SMS, the techniques herein provide “secure SMS” for use with operations dashboards. As described below, secure SMS may also be used for general communications between devices, as well.

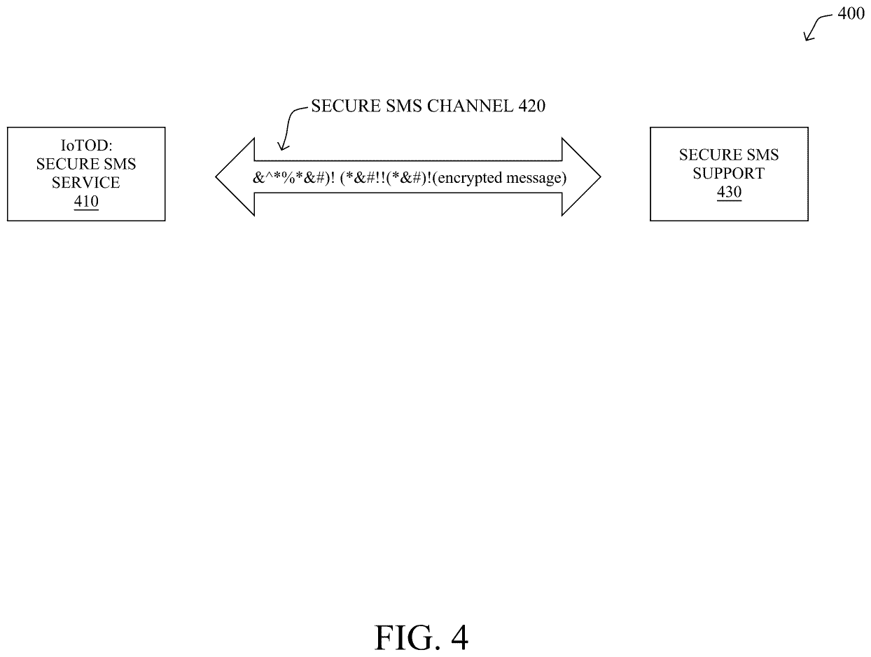

FIG. 4 illustrates an example architecture 400 for a secure short messaging service (SMS) according to one or more embodiments herein. In particular, “secure”herein specifically implies that the communication is encrypted (e.g., all of the communication, or at least certain portions of the communication), such as by using a pre-shared key (PSK) between a first device 410 (e.g., an IoT Operations Dashboard, “IoTOD”) and a second device 430 (e.g., cellular modem, gateway, etc.) to send secure SMS messages 420 (on a secure SMS channel) as an encrypted message. For instance, to share the keys, the techniques herein may bootstrap with a Secure Unique Device Identifier (SUDI) (i.e., a certificate that stores a product's serial number and identifier) or other hardware-based keys.

According to the techniques herein, the output may also be formatted in GSM-7 encoding. That is, secure SMS messages 420 should be encoded in GSM-7 or else they will need to be expanded (e.g., twice as long) to fit the characters of the intended communication.

In one embodiment herein, the techniques may use Advanced Encryption Standard (AES) cipher block chaining (CBC) for the cipher, and a secure hash algorithm (SHA) such as SHA-256, as a hash function to encrypt the SMS message. Certain embodiments may also use a key derivation function (KDF) to ensure forward secrecy (i.e., ensure that cracking one message does not reveal all the past and future messages). Still other embodiments may also implement key rotation.

Note that mobile devices are not needed to send SMS messages to devices. That is, according to one or more specific embodiments herein, the techniques may use a lightweight cloud-based service, generally without external dependencies management (EDM) dependency. In this manner, there is also no need for a user to manage an allowed mobile device list on thousands of routers; the user instead just has to use the IoTOD (or other controller) to send the SMS message.

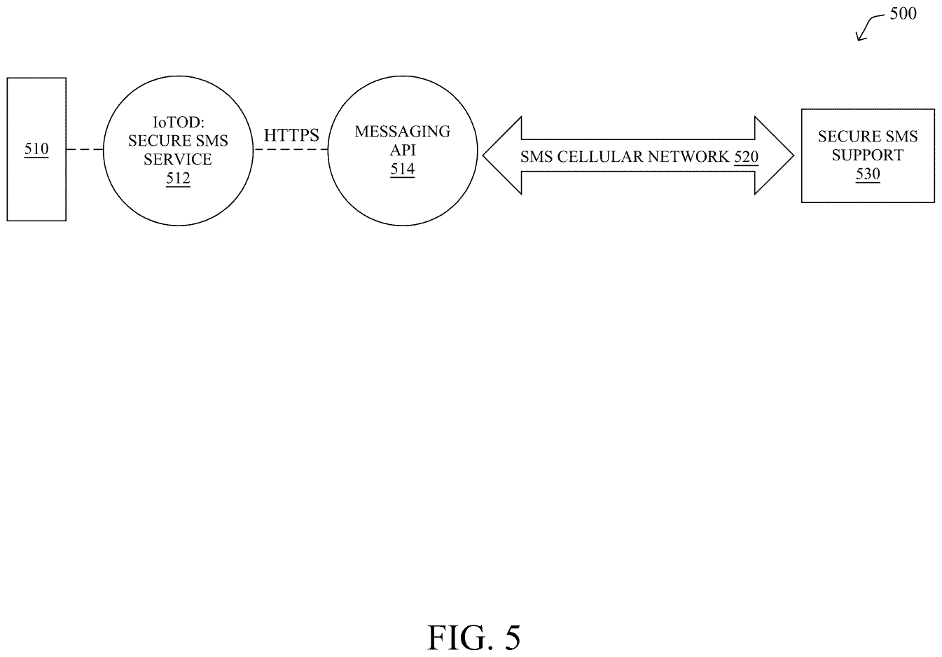

FIG. 5 illustrates an example architecture 500 for a cloud-based secure SMS according to one or more embodiments herein. For instance, as shown, a user device 510 may communicate via a secure SMS service 512 (e.g., an IoTOD service) which can then use a messaging API 514 from a cloud communications service that provides programmable communication tools for making and receiving phone calls, sending and

receiving text messages, and performing other communication functions using web service APIs (e.g., sending an HTTPS message to the messaging API 514 with the desired encrypted communication). The encrypted SMS communication 520 may then proceed between the user device 510 and the end device 530 (e.g., the cellular modem, gateway, second device, etc.) according to the techniques herein.

In this manner, there is the ability to provide a central configuration, role-based access control (RBAC), and audit logs of every message sent to the end device (e.g., gateway). Also, the techniques herein are well suited for automation and analytics (e.g., retries, periodic SMS validation, restarting cellular modems when connectivity is down, etc.).

Additionally, in an alternative use case of secure SMS, device-to-device communication may also directly use secure SMS, when adequately configured. For instance, assume such a system in which there are at least two devices. A majority of the devices could be in “target” role, and can be the target of secure SMS messages (e.g., service commands), such as to query information and to carry out limited set of actions. Some number of devices would be configured to be in “leader” role, and can be used as the interface to the secure SMS service, to issue commands to target devices and to display responses returned. (Any device can be configured as both leader and target roles simultaneously.)

According to this aspect of the present disclosure, a leader device may be configured by generating a leader-specific public/private key pair labelled with a key-id. The key-id must be unique from each target device's point of view, to differentiate between the different leaders configured for the target. The key-id and leader-public-key should be remembered as it will be used in the configuration for the targets.

In particular, each target device may be configured by generating a target-specific public/private key pair. The target-public-key as well as the phone number of the target should be remembered as it will be used to add the target to a leader database. Each target is also configured to respond to one or more leaders, using the key-id and the leader public-key from the leader configuration above.

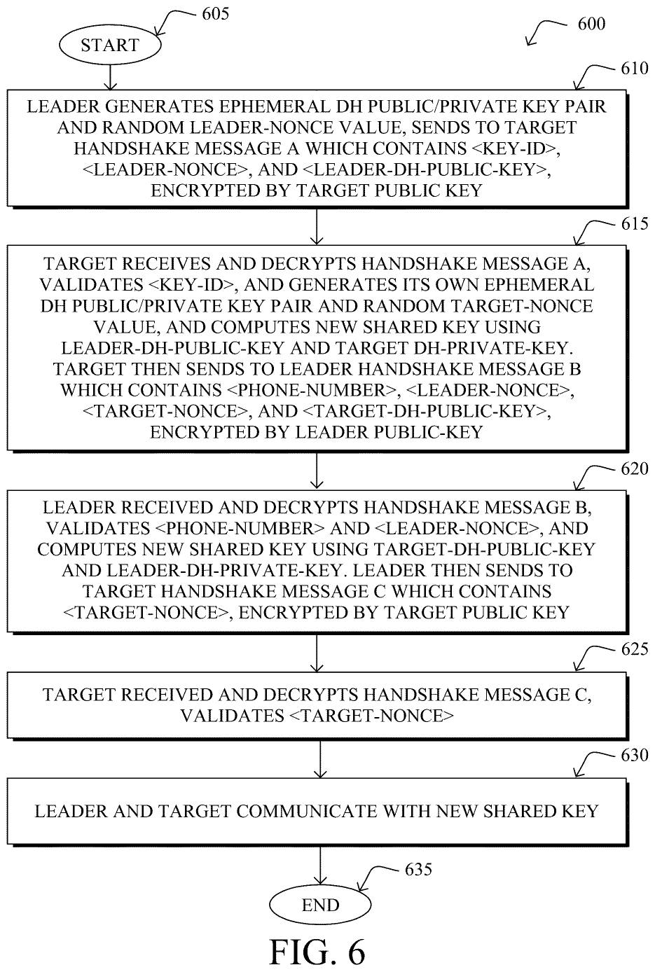

After both the leader and target device(s) are configured, each target can be added to the leader database that maintains all such reachable targets, using the phone number and target public-key from the target configuration. At this point, the leader may initiate onboarding of the target to the system via a handshake process. FIG. 6 illustrates an example procedure 600 for device-to-device secure SMS according to one or more embodiments herein in this manner. The procedure may start in step 605, and continues as follows:
Step 610: The leader generates a public/private key pair (e.g., an ephemeral Diffie-Hellman, or “DH” public/private key pair) and a random leader-nonce value, and sends to the target(s) a handshake message “A”, which herein contains <key-id>, <leader-nonce>, and <leader-dh-public-key>, encrypted by the target public key.
Step 615: The target receives and decrypts handshake message A, validates the <key-id>, and generates its own (e.g., ephemeral DH) public/private key pair and also a random target-nonce value, and computes a new shared key using leader-dh-public-key and the target dh-private-key. The target then sends to leader handshake message “B”, which herein contains <phone-number>, <leader-nonce>, <target-nonce>, and also a <target-dh-public-key>, encrypted by the leader public-key.
Step 620: The leader receives and decrypts handshake message B, validates <phone-number> and <leader-nonce>, and also computes a new shared key using the target-dh-public-key and leader dh-private-key. The leader then sends to the target a handshake message “C”, which contains <target-nonce>, encrypted by target public key.
Step 625: The target receives and decrypts handshake message C, and validates <target-nonce>.
Step 630: At the end of the above steps, both the leader and the target have new shared key that can be used for further communication.

The example procedure 600 may then end in step 635 with the devices now in full secure SMS communication. New keys may be generated over time, and the example procedure 600 may then restart the handshake process accordingly.

Notably, the target may remember limited set of recent commands to mitigate replay attacks, using random numbers generated by the leader. The leader may be configured to only accept the current response it is waiting for. To increase effectiveness of target anti-replay, one embodiment herein excludes harmless commands from the set, such as commands for health checks or channel validation.

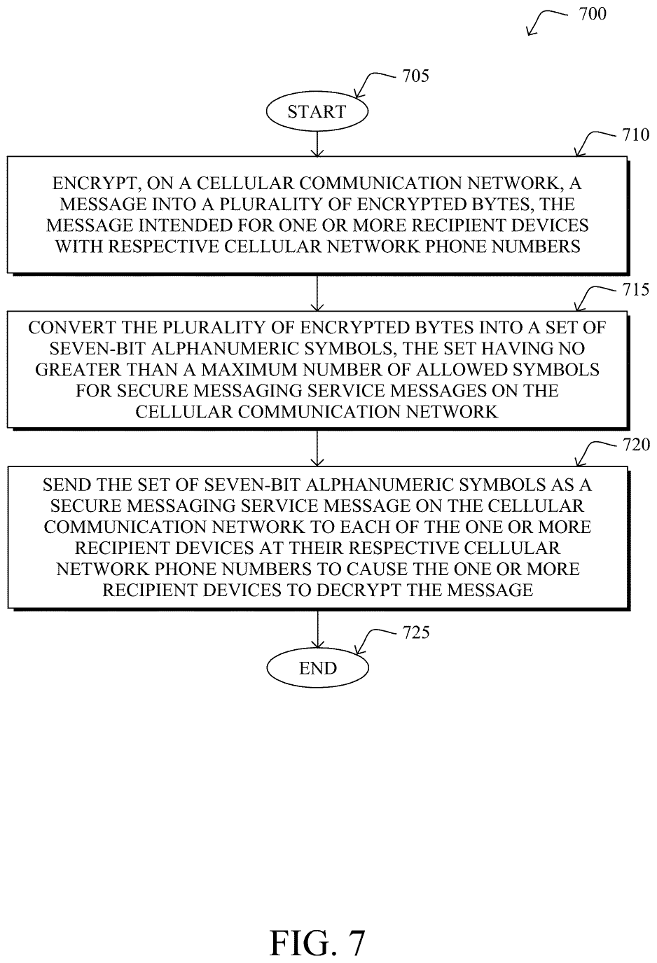

In closing, FIG. 7 illustrates an example simplified procedure for secure SMS in accordance with one or more embodiments described herein. For example, a non-generic, specifically configured device (e.g., device 200, an apparatus) may perform procedure 700 by executing stored instructions (e.g., process 248). The procedure 700 may start at step 705, and continues to step 710, where, as described in greater detail above, a device (e.g., an operator's device, a cloud-device, a communication device for device-to-device secure SMS, etc.) encrypts, on a cellular communication network, a message into a plurality of encrypted bytes, the message intended for one or more recipient devices with respective cellular network phone numbers.

In one embodiment, the message is a control command.

In one embodiment, the message is in response to a primary cellular data channel failing.

In one embodiment, the device is a cloud-based controller.

In one embodiment, the device is a communication device communicating with another communication device. In one further embodiment, the device is a leader communicating commands to one or more target devices. (Further details regarding these embodiments may be found within the description of FIG. 6 above.)

In one embodiment, the one or more recipient devices comprise one or more cellular modems. In one embodiment, the message comprises a troubleshooting message for the one or more cellular modems. In one embodiment, the one or more cellular modems have a failed data channel.

In step 715, the technique herein convert the plurality of encrypted bytes into a set of alphanumeric symbols (e.g., seven-bit), the set having no greater than a maximum number of allowed symbols for secure messaging service messages on the cellular communication network.

In step 720, the techniques herein send the set of alphanumeric symbols (e.g., seven-bit) as a secure messaging service message on the cellular communication network to each of the one or more recipient devices at their respective cellular network phone numbers to cause the one or more recipient devices to decrypt the message.

In one embodiment, the techniques herein further comprise receiving a returned secure messaging service message from the one or more recipient devices.

In one embodiment, the secure messaging service message comprises a short messaging service (SMS) message.

Procedure 700 may end at step 725.

It should be noted that while certain steps within the procedures above may be optional as described above, the steps shown in the procedures above are merely examples for illustration, and certain other steps may be included or excluded as desired. Further, while a particular order of the steps is shown, this ordering is merely illustrative, and any suitable arrangement of the steps may be utilized without departing from the scope of the embodiments herein. Moreover, while procedures may have been described separately, certain steps from each procedure may be incorporated into each other procedure, and the procedures are not meant to be mutually exclusive.

In some implementations, an illustrative apparatus herein may comprise: one or more network interfaces to communicate with a network; a processor coupled to the one or more network interfaces and configured to execute one or more processes; and a memory configured to store a process that is executable by the processor, the process comprising: encrypting, on a cellular communication network, a message into a plurality of encrypted bytes, the message intended for one or more recipient devices with respective cellular network phone numbers; converting the plurality of encrypted bytes into a set of seven-bit alphanumeric symbols, the set having no greater than a maximum number of allowed symbols for secure messaging service messages on the cellular communication network; and sending the set of seven-bit alphanumeric symbols as a secure messaging service message on the cellular communication network to each of the one or more recipient devices at their respective cellular network phone numbers to cause the one or more recipient devices to decrypt the message.

In still other implementations, a tangible, non-transitory, computer-readable medium storing program instructions that cause a device to execute a process comprising: encrypting, on a cellular communication network, a message into a plurality of encrypted bytes, the message intended for one or more recipient devices with respective cellular network phone numbers; converting the plurality of encrypted bytes into a set of seven-bit alphanumeric symbols, the set having no greater than a maximum number of allowed symbols for secure messaging service messages on the cellular communication network; and sending the set of seven-bit alphanumeric symbols as a secure messaging service message on the cellular communication network to each of the one or more recipient devices at their respective cellular network phone numbers to cause the one or more recipient devices to decrypt the message.

The techniques described herein, therefore, provide for secure SMS. In particular, the techniques herein use the cellular SMS network with end-to-end encryption by specifically encrypting a message, converting that message into seven-bit symbols (GSM) that would fit within an SMS message, to send an encrypted message over SMS. The details above offer control-based use cases and responsiveness, as well as provisions for how to exchange encryption keys and other security considerations for secure SMS communications between networking devices.

As mentioned above, there are existing solutions that provide for an SMS-based backup channel for networking devices. However, they are not secure (e.g., password in the clear), are difficult to manage (cross-product problem of configuring a number of operators times a number of devices), and might only transmit limited information in SMS messages due to lack of control of the message content. Methods for encrypting messages over SMS currently utilize “unreadable links” that launch a mobile application to deliver information using encryption keys, which is a much more complicated process that still requires a secondary network to access the links/URLs to obtain the messages. Other concepts of backup communication channels require an additional communication network to be available within range of the device, which is unlikely given that these are remote locations. SMS-based solutions make more sense since the devices are already connected to a cellular network, and SMS service should be available using the same cellular network. The techniques herein, on the other hand, do not suffer from any of these shortcomings.

Illustratively, the techniques described herein may be performed by hardware, software, and/or firmware, (e.g., an “apparatus”) such as in accordance with the secure SMS process, process 248, e.g., a “method”), which may include computer-executable instructions executed by the processor(s) 220 to perform functions relating to the techniques described herein, e.g., in conjunction with corresponding processes of other devices in the computer network as described herein (e.g., on agents, controllers, computing devices, servers, etc.). In addition, the components herein may be implemented on a singular device or in a distributed manner, in which case the combination of executing devices can be viewed as their own singular “device” for purposes of executing the process (e.g., process 248).

While there have been shown and described illustrative implementations above, it is to be understood that various other adaptations and modifications may be made within the scope of the implementations herein. For example, while certain implementations are described herein with respect to certain types of networks in particular, the techniques are not limited as such and may be used with any computer network, generally, in other implementations. Moreover, while specific technologies, protocols, architectures, schemes, workloads, languages, etc., and associated devices have been shown, other suitable alternatives may be implemented in accordance with the techniques described above. In addition, while certain devices are shown, and with certain functionality being performed on certain devices, other suitable devices and process locations may be used, accordingly.

In addition, while references are made to IoT, IoT networking devices, IoTOD, and so on, any controller system that manages devices can be used herein, such as, for instance, an SD-WAN Manager, field network director (FND), and so forth. As such, IoT, IoT networking devices, and IoTOD are not meant to be limiting to the scope of the embodiments herein.

Moreover, while the present disclosure contains many other specifics, these should not be construed as limitations on the scope of any implementation or of what may be claimed, but rather as descriptions of features that may be specific to particular implementations. Certain features that are described in this document in the context of separate implementations can also be implemented in combination in a single implementation. Conversely, various features that are described in the context of a single implementation can also be implemented in multiple implementations separately or in any suitable sub-combination. Further, although features may be described above as acting in certain combinations and even initially claimed as such, one or more features from a claimed combination can in some cases be excised from the combination, and the claimed combination may be directed to a sub-combination or variation of a sub-combination.

Similarly, while operations are depicted in the drawings in a particular order, this should not be understood as requiring that such operations be performed in the particular order shown or in sequential order, or that all illustrated operations be performed, to achieve desirable results. Moreover, the separation of various system components in the implementations described in the present disclosure should not be understood as requiring such separation in all implementations.

The foregoing description has been directed to specific implementations. It will be apparent, however, that other variations and modifications may be made to the described implementations, with the attainment of some or all of their advantages. For instance, it is expressly contemplated that the components and/or elements described herein can be implemented as software being stored on a tangible (non-transitory) computer-readable medium (e.g., disks/CDs/RAM/EEPROM/etc.) having program instructions executing on a computer, hardware, firmware, or a combination thereof. Accordingly, this description is to be taken only by way of example and not to otherwise limit the scope of the implementations herein. Therefore, it is the object of the appended claims to cover all such variations and modifications as come within the true intent and scope of the implementations herein.

What is claimed is:

1. A method, comprising:
encrypting, by a device, on a cellular communication network, a message into a plurality of encrypted bytes, the message intended for one or more recipient devices with respective cellular network phone numbers;
converting, by the device, the plurality of encrypted bytes into a set of seven-bit alphanumeric symbols, the set of seven-bit alphanumeric symbols having no greater than a maximum number of allowed symbols for secure messaging service messages on the cellular communication network; and
sending, by the device, the set of seven-bit alphanumeric symbols as a secure messaging service message on the cellular communication network to each of the one or more recipient devices at their respective cellular network phone numbers to cause the one or more recipient devices to decrypt the message.

2. The method as in claim 1, wherein the message is a control command.

3. The method as in claim 1, wherein the message is in response to a primary cellular data channel failing.

4. The method as in claim 1, wherein the device is a cloud-based controller.

5. The method as in claim 1, wherein the device is a communication device communicating with another communication device.

6. The method as in claim 1, wherein the device is a leader communicating commands to one or more target devices.

7. The method as in claim 1, wherein the one or more recipient devices comprise one or more cellular modems.

8. The method as in claim 7, wherein the message comprises a troubleshooting message for the one or more cellular modems.

9. The method as in claim 7, wherein the one or more cellular modems have a failed data channel.

10. The method as in claim 1, further comprising receiving a returned secure messaging service message from the one or more recipient devices.

11. The method as in claim 1, wherein the secure messaging service message comprises a short messaging service (SMS) message.

12. An apparatus, comprising:
one or more network interfaces;
a processor coupled to the one or more network interfaces and configured to execute one or more processes; and
a memory configured to store a process that is executable by the processor, the process when executed configured to:
encrypt on a cellular communication network, a message into a plurality of encrypted bytes, the message intended for one or more recipient devices with respective cellular network phone numbers;
convert the plurality of encrypted bytes into a set of seven-bit alphanumeric symbols, the set of seven-bit alphanumeric symbols having no greater than a maximum number of allowed symbols for secure messaging service messages on the cellular communication network; and
send the set of seven-bit alphanumeric symbols as a secure messaging service message on the cellular communication network to each of the one or more recipient devices at their respective cellular network phone numbers to cause the one or more recipient devices to decrypt the message.

13. The apparatus as in claim 12, wherein the message is a control command.

14. The apparatus as in claim 12, wherein the message is in response to a primary cellular data channel failing.

15. The apparatus as in claim 12, wherein the apparatus is a cloud-based controller.

16. The apparatus as in claim 12, wherein the apparatus is a communication device communicating with another communication device.

17. The apparatus as in claim 12, wherein the apparatus is a leader communicating commands to one or more target devices.

18. The apparatus as in claim 12, wherein the one or more recipient devices comprise one or more cellular modems.

19. The apparatus as in claim 18, wherein the message comprises a troubleshooting message for the one or more cellular modems.

20. A tangible, non-transitory, computer-readable medium storing program instructions that cause a computer to execute a process comprising:
encrypting on a cellular communication network, a message into a plurality of encrypted bytes, the message intended for one or more recipient devices with respective cellular network phone numbers;
converting the plurality of encrypted bytes into a set of seven-bit alphanumeric symbols, the set of seven-bit alphanumeric symbols having no greater than a maximum number of allowed symbols for secure messaging service messages on the cellular communication network; and
sending, the set of seven-bit alphanumeric symbols as a secure messaging service message on the cellular communication network to each of the one or more recipient devices at their respective cellular network phone numbers to cause the one or more recipient devices to decrypt the message.
